(19) United States
(12) Patent Application Publication
(10) Pub. No.: US 2002/0031229 A1
(43) Pub. Date: Mar. 14, 2002

(54) Deputy information processing system

(75) Inventor: Yoshinobu Yamamoto, Tokyo (JP)

Correspondence Address: WORKMAN NYDEGGER & SEELEY, 1000 EAGLE GATE TOWER, 60 EAST SOUTH TEMPLE, SALT LAKE CITY, UT, 84111, US

(73) Assignee: National Institute of Advanced Industrial Science and Technology

(21) Appl. No.: 09/953,381

(22) Filed: Sep. 12, 2001

(30) Foreign Application Priority Data
Sep. 14, 2000 (JP) 2000-280436

(51) Int. Cl. H04K 1/00

(52) U.S. Cl. 380/270

(57) ABSTRACT

An information system enables an information device to achieve its functions fully by acting for the information device. The information device generates a service code by encoding or encrypting a terminal ID and a service ID corresponding to a target service using a time seed that is updated regularly, and transmits the service code to the server. The server decodes the terminal ID and the service ID from the service code according to a time seed replica generated in synchronism with the time seed in the information device, which is updated regularly. This enables the server to identify the service and the information device that receives the service, thereby preventing an unauthorized access. The service provider executes the service corresponding to the decoded service ID, and the user of the information device can receive the service, and confirm that the service is carried out via a communication medium.

### CROSS-REFERENCE TO RELATED APPLICATIONS

This application claims priority to Japanese Patent Application No. 2000-280436, filed Sep. 14, 2000 in Japan, the content of which is incorporated hereinto by specific reference.

### BACKGROUND OF THE INVENTION

1. The Field of the Invention

The present invention relates to a deputy information processing system.

2. The Relevant Technology

As mobile information terminals, wearable PCs are known. The “wearable PC” is a generic name of compact computers including mobile, portable computers, and is abbreviated to “WPC” in this specification. There are many versatile, high performance WPCs. For example, they have a function to receive information by radio waves. One recent trend is a growing complexity in operating the WPCs because of their versatility (high performance). The complicated operation is a common problem with other ordinary information devices such as those handling video information like VTRs (video tape recorders).

To operate an information device, an input means (human interface) is needed for entering operation information into it.

The input means usually comprises a plurality of keys including touch keys on an information display screen.

A limited number of keys, however, often requires complicated and tedious key operations to achieve complex functions. In addition, as is more evident for elders, they forget how to operate the keys while they do not use the equipment for a while.

Furthermore, even if the operation itself is not so difficult, it is common that many of the functions of the information device are not used effectively.

Accordingly, it is desired to make effective use of the versatility (high performance) of the information device by simple operation.

### BRIEF SUMMARY OF THE INVENTION

The present invention is implemented to solve the foregoing problems.

Another object of the present invention is to positively utilize external information resources by making effective use of an information device.

According to a first aspect of the present invention, there is provided an information device comprising: a time seed generating section for generating a time seed that is updated regularly; a target service information input section for inputting information about a target service; and a service code generating section for generating a service code by encoding or encrypting a terminal ID and a service ID using the time seed, wherein the terminal ID is assigned to the information device for identifying the information device, the service ID corresponds to the information input from the target service information input section, and the time seed is generated by the time seed generating section.

Here, the information device may further comprise an external information processing section for capturing external information corresponding to the generated service code, and for carrying out processing of the external information.

The external information processing section may comprise a receiver for receiving the external information from a medium that transmits the external information.

According to a second aspect of the present invention, there is provided an information processing unit comprising: a decoding section for decoding a terminal ID and a service ID from a service code according to a time seed replica, wherein the service code is generated by an information device that encodes or encrypts, by using a time seed updated regularly, the terminal ID for identifying the information device and the service ID corresponding to information associated with a target service, and the time seed replica is updated regularly in synchronization with the time seed; and a control section for controlling a processing associated with execution of a service corresponding to the decoded service ID, and for sending a result of the service processing to the information device via the communication medium according to the decoded terminal ID.

According to a third aspect of the present invention, there is provided a deputy information processing method comprising the steps of: generating a service code by encoding or encrypting a terminal ID and a service ID by an information device using a time seed that is updated regularly, the terminal ID being assigned to the information device for identifying it and the service ID corresponding to information associated with a target service; sending the service code generated and output by the information device to an information processing unit via a communication section; decoding the terminal ID and the service ID from the service code sent to the information processing unit according to a time seed replica that is updated regularly in synchronization with the time seed in the information device; controlling a processing of a service corresponding to the decoded service ID in the information processing unit; and transmitting a result of the service processing from the information processing unit to the information device via the communication section according to the decoded terminal ID.

When the decoded service ID is a service that requires voice information for controlling the service processing, the information processing unit may connect a voice communication enabling means to the communication section used for sending the service code.

The communication section used for sending the service code may be a public network capable of transmitting voice information.

The communication section used for sending the service result to the information device may include a public network for transmitting the service processing result.

The above and other objects, effects, features and advantages of the present invention will become more apparent from the following description of embodiments thereof taken in conjunction with the accompanying drawings.

### BRIEF DESCRIPTION OF THE DRAWINGS

FIG. 1 is a flowchart illustrating a basic processing of the present invention;

FIG. 2 is a block diagram showing a configuration of a mobile information terminal as an example of the information device in accordance with the present invention;

FIG. 3 is an external view of the mobile information terminal;

FIG. 4 is a block diagram showing a configuration of a server as an information processing unit on a service provider side; and

FIG. 5 is a flowchart illustrating an example of the processing of the server.

### DETAILED DESCRIPTION OF THE PREFERRED EMBODIMENTS

The invention will now be described with reference to the accompanying drawings.

Embodiment 1

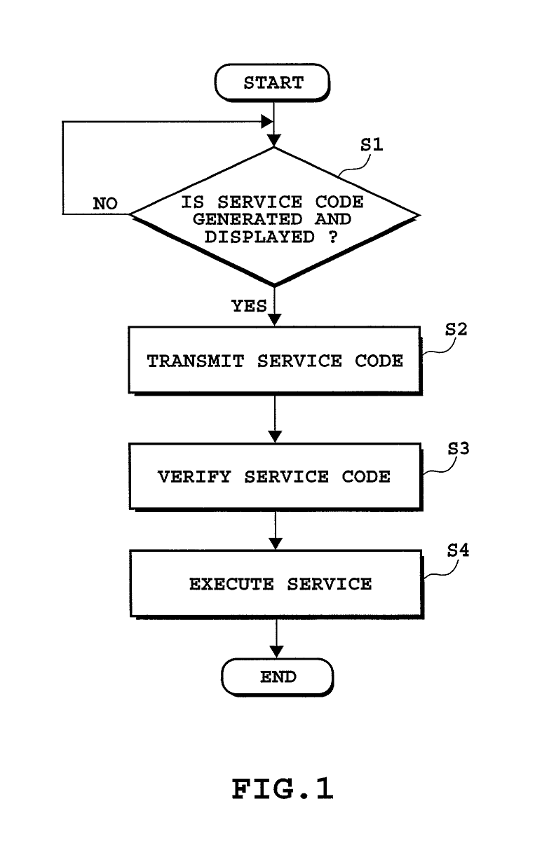

FIG. 1 is a flowchart illustrating the operation of a deputy information processing method in accordance with the present invention.

Activated by power on, an information device, the details of which will be described later, generates a service code at step S1. The service code is necessary for a user of the information device to request a service provider (the details of which will be described later) for deputy information processing of the information device. The service code is generated by encoding or encrypting a terminal ID and a service ID using a time seed that is regularly updated by the information device. Here, the terminal ID is for identifying the information device, and the service ID provides information about a service to be provided.

At the next step S2, the information device transmits the service code to the predetermined equipment of the service provider for executing the deputy information processing (for example, to a server connected to a public telephone network). In the foregoing example, the information device is connected to the server using a telephone set, and the service code is sent to an operator.

At the subsequent step S3, the server that receives the service code decodes the terminal ID and the service ID from the service code according to the time seed that is updated regularly in synchronism with the time seed in the information device. Thus, the service provider can identify the service to be provided and the service information device to be provided with the service, making it possible to eliminate unauthorized access. For example, even if a service code is sent to play a prank, the server will be unable to decode the terminal ID or the service ID unless they are encoded/encrypted according to the correct time seed, making it possible to prevent fraud. As for the charges for services, the contractor with the service provider, that is, the owner of the information device associated with the terminal ID, usually bears the charges. However, since other people can use the information device without permission, a user ID (along with the terminal ID) is assigned to the contractor at the contact. Thus, if the user ID is transmitted by voice or key input in advance, the server can verify the user ID before the service code is transmitted, and prevent the service code from being decoded if the user ID is unauthorized. The user ID and terminal ID each consist of six alphanumeric codes, for example.

At the next step S4, the server executes the service for the service ID it decodes. Although the details will be described later, the contents of the service are limitless, and the service provider can charge the user of the information device for the service in accordance with its contents (degree and time). The result of the service processing is transmitted to the information device via a communication medium, which is a telephone in the foregoing case. However, the communication medium is not limited to the telephone, the details of which will be described later. Thus, the user of the information device can confirm and receive the service. Although the services can be provided in real time interactively, they can be received later or regularly.

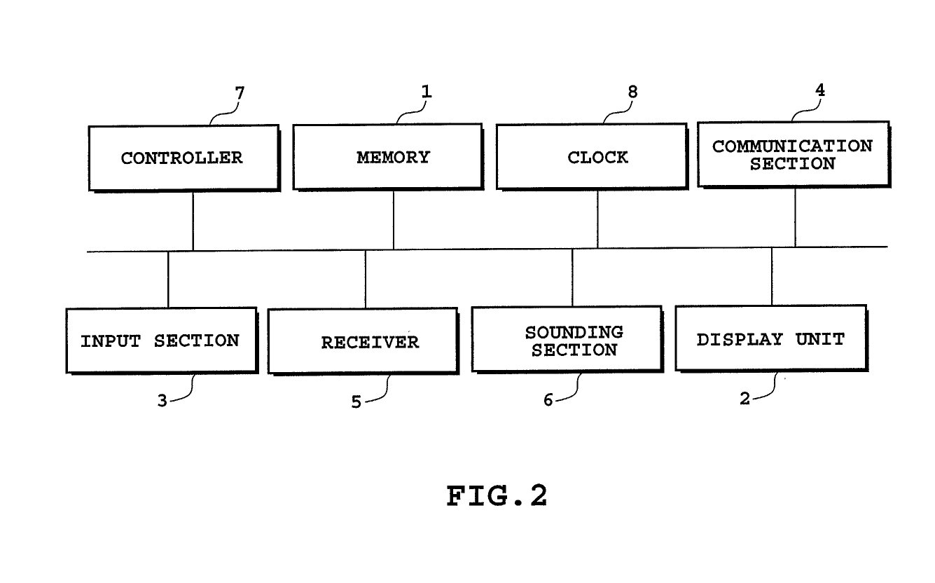

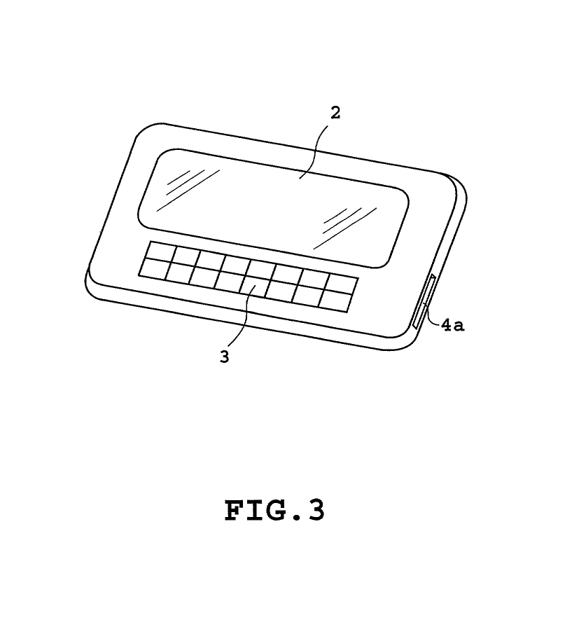

FIG. 2 is a block diagram showing a mobile information terminal as an example of the information device in accordance with the present invention, and FIG. 3 is its external view.

In FIG. 2, the reference numeral 1 designates a memory for storing an ID (terminal ID) uniquely assigned to the mobile information terminal and other information such as menu information and service ID information corresponding to the menu information. The memory can be a memory card that is attachable to or detachable from the information terminal. The service provider can provide the memory card. The reference numeral 2 designates a display unit such as a liquid crystal display; 3 designates an input section including a plurality of keys (plus a microphone for inputting speech as needed). The display unit 2 and the input section 3 enable the user to conduct interaction. Such a configuration is also possible as comprises touch keys on the display unit 2 as a part of the input section. The reference numeral 4 designates a communication section for carrying out communication with the information processing server via a public network such as a wired telephone, mobile telephone or PHS (Personal Handyphone System), and/or the Internet. The communication section 4 has a modem, and can establish a connection with the public network or the Internet via a cord connected to a connector 4a. The reference numeral 5 designates a receiver for receiving radio waves of a predetermined frequency, and for extracting necessary information by demodulating (decoding) the received signal; and 6 designates a sounding section for generating prescribed electronic sounds, composite sounds in response to an input signal, or speech sounds obtained by demodulating the received signal. The sounding section 6 can be replaced by a vibrator. The reference numeral 7 designates a controller for controlling the foregoing components 1-6; and 8 designates a clock. The foregoing components operate using an internal battery not shown in this figure as their power supply. The controller 7 comprises a CPU and a system memory, and the CPU executes the processing in accordance with programs stored in the system memory with reference to clock data of the clock 8 when necessary.

The mobile information terminal with the foregoing configuration operates as follows under the control of the controller 7. First, it is turned on by a power switch that is not shown or assigned to a predetermined key on the input section 3. Then, a menu display key on the input section 3 is pressed to display a menu on the display unit 2. The menu has a hierarchical structure with a required number of levels under each of several top menus so that a target menu can be selected by sequentially tracing the menus of the tree structure by a cursor key or a confirmation key. Examples of the top menus are as follows.

1. Deputy input by an operator.

2. Search for telephone number.

3. Information about traffic and destination.

4. Memo pad.

5. Online shopping.

For example, selecting the online shopping will display the following menu options.

1. Information about bargains

2. Convenience goods

3. Groceries

4. Furniture

5. Books

6. Other articles

In response to the selection of one of the online shopping menu options by the cursor key, followed by depression of the confirmation key, the controller 7 reads a service ID corresponding to the selected menu option from the memory 1. Then, the controller 7 generates a time seed at that time referring to the time data of the clock 8 (the time seed is a 3-bit value updated regularly (at every 10 minute interval, for example)). Using the generated time seed, the controller 7 encodes or encrypts the terminal ID of the mobile information terminal and the service ID corresponding to the selected menu option, and displays a seven-digit alphanumerical data on the display unit 2 as a service code. The process of generating and displaying the service code corresponds to step S1 of FIG. 1.

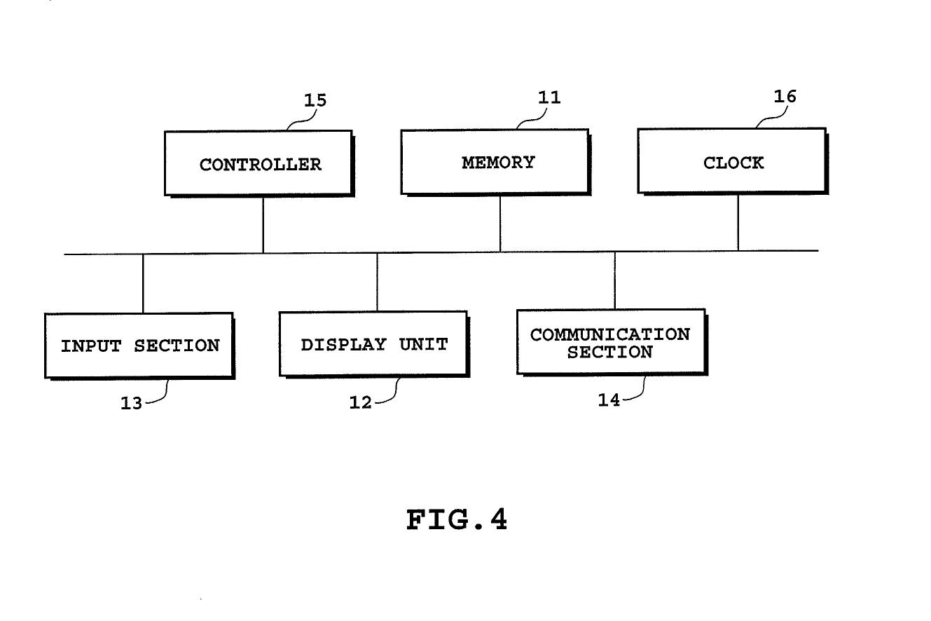

FIG. 4 is a block diagram showing a portion relevant to the present invention of a server constituting an information processing unit as a facility of a service provider side. It can be constructed utilizing an ordinary computer system with a means for connecting it to a communication medium such as a public network or private line.

In FIG. 4, the reference numeral 11 designates a memory for storing user IDs for identifying contractors, IDs (terminal IDs) uniquely assigned to the mobile information terminals of the contractors, and other information such as menu information and service ID information corresponding thereto. The reference numeral 12 designates a display unit such as a liquid crystal display; and 13 designates an input section including a plurality of keys. The two portions serve to interact with the user. The reference numeral 14 designates a communication section for establishing a connection with a public network such as a fixed telephone, mobile telephone or PHS and/or the Internet, and for communicating with users and/or information devices. The communication section 14 includes a facility for allowing an operator to communicate with a user by voice or dial tone (an ordinary telephone set, for example), together with a synthesized sound generator. The reference numeral 15 designates a controller for controlling the foregoing components 11-14; and 16 designates a clock. The controller 15 comprises a CPU and a system memory. The CPU executes its processing in accordance with programs stored in the system memory referring to the clock data in the clock 16 as needed.

The server with the foregoing configuration operates as follows under the control of the controller 15. The operation will be described by example in which the user calls the server (the telephone number of the communication section) of the service provider from an ordinary fixed telephone of the user via a common wired network, and a connection is established when an operator answers the incoming call to the communication section of the server.

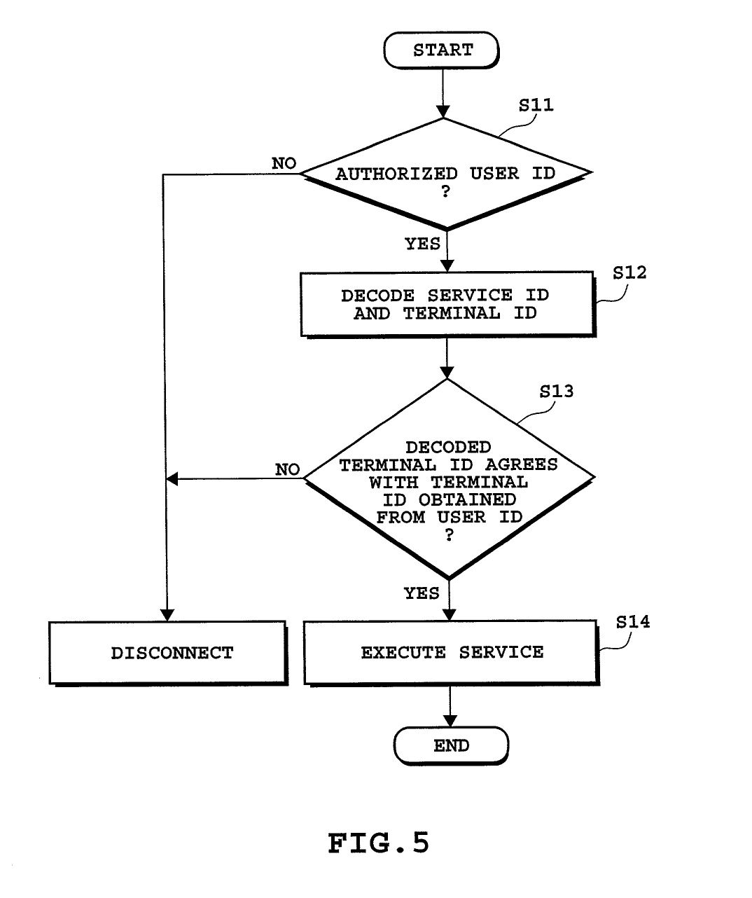

FIG. 5 is a flowchart illustrating the operation. First, at step S11, the operator asks the user about the user ID, and the user answers the operator with the user ID by voice. Receiving it, the operator inputs the user ID from the input section 13 so that a decision is made whether it agrees with the user ID in the memory 11 (the result of the decision can be displayed on the display unit 12). If it is an unauthorized user ID, that is, if the memory 11 includes no identical ID, the operator states the matter to the user, and disconnects the line. On the other hand, when the same user ID is found in the memory 11, it is decided as an authorized ID, and the processing proceeds to the next step S12.

At step S12, the user of the mobile information terminal is requested to send the service code, and the user sends the service code displayed on the display unit of the mobile information terminal by voice. Receiving it, the operator inputs the service code from the input section 13. On the other hand, the controller 15 generates the time seed from the clock data of the clock 16 (the time seed is regularly updated in synchronism with the clock of the mobile information terminal), and decodes the terminal ID of the mobile information terminal and the service ID from the input service code using the time seed generated. They can be displayed on the display unit 12. If they cannot be decoded, the decoding is carried out using the first previous time seed. If they cannot be decoded yet as in a case where a considerable time period has elapsed from the generation of the service code, an error message is displayed on the display unit 12, and the operator sends a notice to the user of the matter.

At the next step S13, the controller 15 makes a decision as to whether the decoded terminal ID agrees with the terminal ID that corresponds to the user ID that is stored in the memory 11 and obtained at step S11. If they disagree, the processing is made for notifying the user of the matter, followed by the disconnection of the channel. In contrast, when they agree, the processing proceeds to step S14. The foregoing processing corresponds to step S3.

At step S14, the service corresponding to the service ID (the menu option corresponding to the service ID) is carried out. More specifically, when the menu option is the information about traffic and destination, a new operator specializing (or sharing) the information about traffic and destination asks the user about the details, and the user answers by voice. Receiving it, the operator prepares the reply, and sends it to the user. The mode of the notification is various. For example, it can be sent by voice; or by fax when the information is about a map or the like, or by transmitting data to the mobile information terminal (after disconnecting the connection once) to be displayed on the display unit of the mobile information terminal. The reception number can also be sent at the same time. The reception number is effective in such a case as an operator cannot satisfy the intention of the user. In such a case, the user can notify the operator's supervisor or section of the reception number so that the complaint to the operator can be handled positively. The reception number can be recorded in the memory within the server along with the record of the service, so that it can be provided to the user when requested.

At step S14, when the menu option of the deputy input (of the mobile information terminal) by the operator is selected, an expert operator carries out the service by making explanations or repeating questions and answers about the key operation to the user who does not know the operation steps.

The above is an explanation of the basic operation of the present invention. The present invention includes a variety of embodiments.

(Embodiment 1)

As information devices, there are devices generally called information electrical appliances such as videocassette recorders and microwave ovens. Such a device is provided with the configuration as shown in FIG. 2. For example, the input section of FIG. 2 is supplied with the operation information from the operation key pad of the device as well as from a “help button” as one of the components of the input section and a microphone installed at an appropriated location of the device. Furthermore it is enough for the device to have a modem connectable to a telephone line as the communication section, and a speaker as the sounding section that can output the voice of an operator at the service provider side obtained by the communication section. The configuration enables the modem to be connected to the telephone line, enables the controller to generate the service code in response to the depression of the help button, and enables the server on the service provider side to receive the service code. Thus, the service can be implemented as shown in FIG. 1. For example:

(1) Press the help button.

(2) In response to the depression, the controller of the device generates the service code, and dials the telephone number of the service center (the server of FIG. 4) specifically used for the device to establish a connection. After the connection is established, the device sends the user ID, service code and the current state of the device such as information about the remaining amount of the video tape currently inserted into the videocassette recorder in accordance with a prescribed control procedure. In this case, because of little probability of unauthorized use, the steps are carried out quickly such as the verification of the user ID, the decode of the service code and the terminal ID, and a decision making as to the coincidence between the decoded terminal ID and the user ID stored in the memory of the service center. Subsequently, the current state of the device is sent so that its content is displayed on the display unit and the service is executed immediately. Thus, such a vocal inquiry as “What's the matter with you?” is output from the speaker.

(3) In response to it, the user talks to the microphone such as “I want to record a two-hour drama from half past five”.

(4) In response to it, watching the current state of the videocassette recorder shown on the display unit, the operator states such a message as “All right. The current videotape cannot record the two-hour video in its remaining space. Please insert new videotape . . . All right. The reception number is N32. If your screen displays this reception number N32, the current reception has been completed positively. Thank you very much.” Thus, the service is carried out.

(Embodiment 2)

At step S14 of FIG. 5, the service request from the user can be transferred to a telephone of a home-based operator separated apart from the server in accordance with the content of the menu option sent from the user, so that the home-based operator can perform the service. The number of the steps taken by the home-based operator can be reflected on the compensation for the home-based operator, and the connection duration can be reflected on the profit of the service provider.

(Embodiment 3)

At step S14 of FIG. 5, it is possible for the service provider to transmit advertisement information to the mobile information terminal that is connected to the prescribed telephone number of the service provider via the telephone network so that the advertisement data associated with the service is displayed on the display unit of the mobile information terminal. For example, in addition to general advertisement information, information associated with the menu option requested by the user such as advertisement information of travel agents or hotels when the request of the user is an airplane ticket reservation. Thus, if the mobile terminal accepts such an advertisement, its service fee to be paid to the service provider can be reduced. Furthermore, by accumulating the information about the advertisement screen the user watches, and sending the accumulated result to the service provider every ten times of accesses, for example, the service provider can grasp the watched state of the advertisement.

(Concrete Example of Menu (Services))

The present invention is applicable for providing a deputy computation by a main frame computer. The service can be implemented by determining all the parameters necessary for the computation, and by assigning the parameters to the service ID.

The present invention is also applicable not only to games and auctions, but also to application documents to government offices.

The histories of the works can be accumulated in the server side, so that they can be utilized for new services.

As described above, the present invention enables the functions of the information device to be achieved sufficiently with simple operation. In addition, utilizing the functions of the information device makes it possible to make full use of the external information resources.

The present invention has been described in detail with respect to preferred embodiments, and it will now be apparent from the foregoing to those skilled in the art that changes and modifications may be made without departing from the invention in its broader aspects, and it is the intention, therefore, in the appended claims to cover all such changes and modifications as fall within the true spirit of the invention.

What is claimed is:

1. An information device comprising:
a time seed generating section for generating a time seed that is updated regularly;
a target service information input section for inputting information about a target service; and
a service code generating section for generating a service code by encoding or encrypting a terminal ID and a service ID using the time seed, wherein the terminal ID is assigned to said information device for identifying said information device, the service ID corresponds to the information input from said target service information input section, and the time seed is generated by said time seed generating section.

2. The information device as claimed in claim 1, further comprising an external information processing section for capturing external information corresponding to the generated service code, and for carrying out processing of the external information.

3. The information device as claimed in claim 2, wherein said external information processing section comprises a receiver for receiving the external information from a medium that transmits the external information.

4. An information processing unit comprising:
a decoding section for decoding a terminal ID and a service ID from a service code according to a time seed replica, wherein the service code is generated by an information device that encodes or encrypts, by using a time seed updated regularly, the terminal ID for identifying the information device and the service ID corresponding to information associated with a target service, and the time seed replica is updated regularly in synchronization with the time seed; and
a control section for controlling a processing associated with execution of a service corresponding to the decoded service ID, and for sending a result of the service processing to the information device via the communication medium according to the decoded terminal ID.

5. A deputy information processing method comprising the steps of:
generating a service code by encoding or encrypting a terminal ID and a service ID by an information device using a time seed that is updated regularly, the terminal ID being assigned to the information device for identifying it and the service ID corresponding to information associated with a target service;
sending the service code generated and output by said information device to an information processing unit via a communication section;
decoding the terminal ID and the service ID from the service code sent to said information processing unit according to a time seed replica that is updated regularly in synchronization with the time seed in the information device;
controlling a processing of a service corresponding to the decoded service ID in said information processing unit; and
transmitting a result of the service processing from said information processing unit to said information device via the communication section according to the decoded terminal ID.

6. The deputy information processing method as claimed in claim 5, wherein when the decoded service ID is a service that requires voice information for controlling the service processing, said information processing unit connects voice communication enabling means to the communication section used for sending the service code.

7. The deputy information processing method as claimed in claim 5, wherein the communication section used for sending the service code is a public network capable of transmitting voice information.

8. The deputy information processing method as claimed in claim 5, wherein the communication section used for sending the service result to the information device includes a public network for transmitting the service processing result.

9. The deputy information processing method as claimed in claim 6, wherein the communication section used for sending the service result to the information device includes a public network for transmitting the service processing result.

10. The deputy information processing method as claimed in claim 7, wherein the communication section used for sending the service result to the information device includes a public network for transmitting the service processing result.
